(19) United States
(12) Patent Application Publication
(10) Pub. No.: US 2002/0026441 A1
(43) Pub. Date: Feb. 28, 2002

(54) System and method for integrating multiple applications

(76) Inventors: Ali Kutay, Palo Alto, CA (US); Eliahu Albek, San Francisco, CA (US); Cihan Akin, Redwood City, CA (US); Erhan C. Akin, Foster City, CA (US); Hakan Akin, San Mateo, CA (US); John Gilbert, Belmont, CA (US)

Correspondence Address: Florin Corie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/875,465

(22) Filed: Jun. 5, 2001

Related U.S. Application Data
(60) Provisional application No. 60/209,713, filed on Jun. 5, 2000.

(51) Int. Cl. G06F 17/30; G09G 5/00

(52) U.S. Cl. 707/5; 707/10; 345/700

(57) ABSTRACT

A system and method for integrating multiple applications are described. Multiple data items related to a request from a user to present data pertaining to an item and collected from multiple disparate data sources are retrieved from the disparate data sources. Each data item retrieved from the disparate data sources pertains to a distinct aspect of the item. The retrieved data items are then displayed in one or more windows for the user.

The present application claims the benefit of U.S. Provisional Patent Application Ser. No. 60/209,713, filed on Jun. 05, 2000 and entitled “METHODS AND SYSTEMS FOR ACCESSING, ORGANIZING, PRESENTING, AND VIEWING DATA,” and further claims the benefit of U.S. Provisional Patent Application Ser. No. 60/271,080, filed on Feb. 23, 2001 and entitled “SYSTEM AND METHOD FOR INTEGRATING MULTIPLE APPLICATIONS.”

### FIELD OF THE INVENTION

The present invention relates generally to data representation and, more particularly, to a system and method for integrating multiple applications.

### BACKGROUND

As networks have been able to transmit and deliver information faster, users have begun to expect instantaneous delivery of information from any site around the world.

In the “information age,” users are being presented with an ever-increasing volume of information. The presentation format of such information should ideally allow a user to quickly assess the relevance of a large number of information items, and then efficiently access information items that are deemed to the relevance and interest. The broader acceptance of the Internet as an information source, and specifically the acceptance of the World Wide Web, has dramatically increased the volume of information that is available to users. Information retrieval from this vast information source is often facilitated through a search engine. Further, once the user has access to a particular web site, navigation of the various web pages and other information resources that constitute the web site may be confusing and disorienting. Specifically, the structure of a web site is typically hierarchical, and a user may become disoriented or “lost” within the web site.

Especially when data available on a web site is interrelated to data available on other web sites, the content provider has to replicate the large amount of data available on the other web sites in order to create the right combination of information for the user. However, this creates a burden on the Internet infrastructure. At the same time, the content provider runs the risk of reflecting inaccurate information, if it fails to capture updates to interrelated data available on the other web sites.

### SUMMARY

A system and method for integrating multiple applications are described. Multiple data items related to a request from a user to present data pertaining to an item and collected from multiple disparate data sources are retrieved from the disparate data sources. Each data item retrieved from the disparate data sources pertains to a distinct aspect of the item. The retrieved data items are then displayed in one or more windows for the user.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a conventional network architecture.

FIG. 2 is a block diagram of one embodiment for the network including a system for integrating multiple applications.

FIG. 3 is a block diagram of a conventional computer system.

FIG. 4A is a block diagram of one embodiment for a server within the network illustrated in FIG. 1.

FIG. 4B is a block diagram of one embodiment for server routines within the server.

FIG. 5 is a block diagram of one embodiment for a data structure.

FIG. 6 is a block diagram of one embodiment for a query.

FIG. 7A is a block diagram of one embodiment for a system for integrating multiple applications.

FIG. 7B illustrates an exemplary display window for the system.

FIG. 8 is a flow diagram of one embodiment for a method for creating data reference structures within the server.

FIGS. 8A-8B illustrate exemplary interfaces to create the data reference structures.

FIG. 9 is a flow diagram of one embodiment for a method for creating data structures within the server.

FIGS. 9A-9E illustrate exemplary interfaces to create the data structures.

FIG. 10 is a flow diagram of one embodiment for a method for creating a display page within the server.

FIG. 10A is an exemplary interface to create the display page.

FIG. 11 is a flow diagram of one embodiment for a method for integrating multiple applications.

### DETAILED DESCRIPTION

According to embodiments described herein, a system and method for integrating multiple applications are described.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

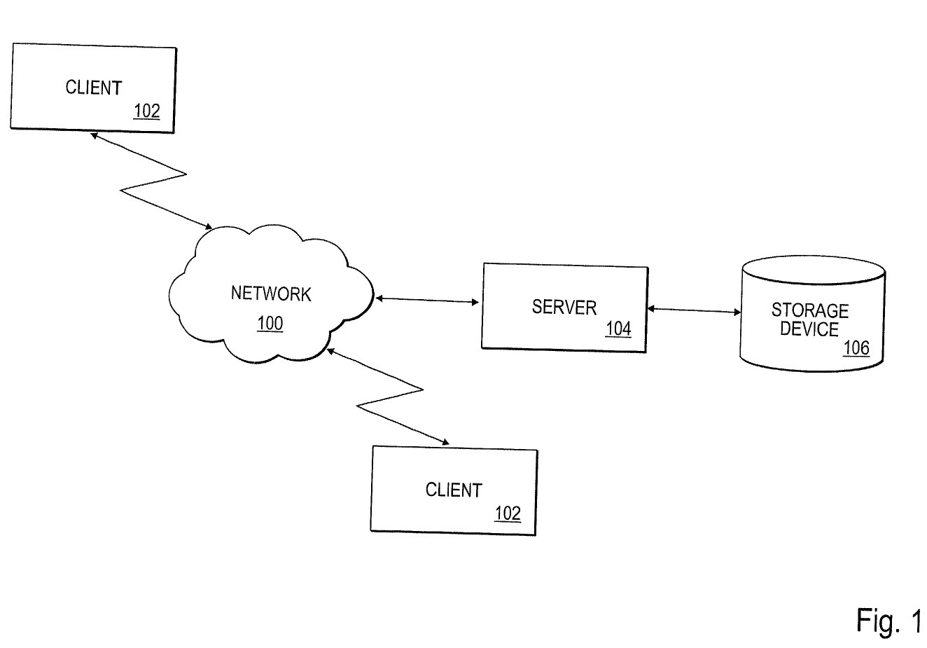

FIG. 1 is a block diagram of a conventional network architecture. Referring to FIG. 1, the block diagram illustrates the network environment in which the present invention operates. In this conventional network architecture, a server computer system, for example application server 104, is coupled to a network 100, for example a wide-area network (WAN). Wide-area network 100 includes the Internet, specifically the World Wide Web (Web), or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, and other conventional means for routing data between computers. Using conventional network protocols, server 104 may communicate through wide-area network 100 to a plurality of client computer systems 102, possibly connected through wide-area network 100 in various ways or directly connected to server 104. For example, as shown in the embodiment of FIG. 1, client 102 is connected directly to wide-area network 100 through direct or dial-up telephone or other network transmission line. Alternatively, client 102 may be connected to wide-area network 100 through a conventional modem pool (not shown).

Using one of a variety of network connection devices, server computer 104 can also communicate directly with client 102. In a particular implementation of this network configuration, a server computer 104 may operate as a web server if the Web portion of the Internet is used as wide-area network 100. Using the Hyper Text Transfer Protocol (HTTP) and the Hyper Text Markup Language (HTML) across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Washington, the user interface of America Online™, or the web browser or HTML translator of any other conventional supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

In one embodiment, server 104 is connected to a storage device 106. The storage device 106 may be any suitable storage medium, for example a read only memory (ROM), a random access memory (RAM), EPROMs, EEPROMs, magneto-optical discs, or any other type of medium suitable for storing electronic data.

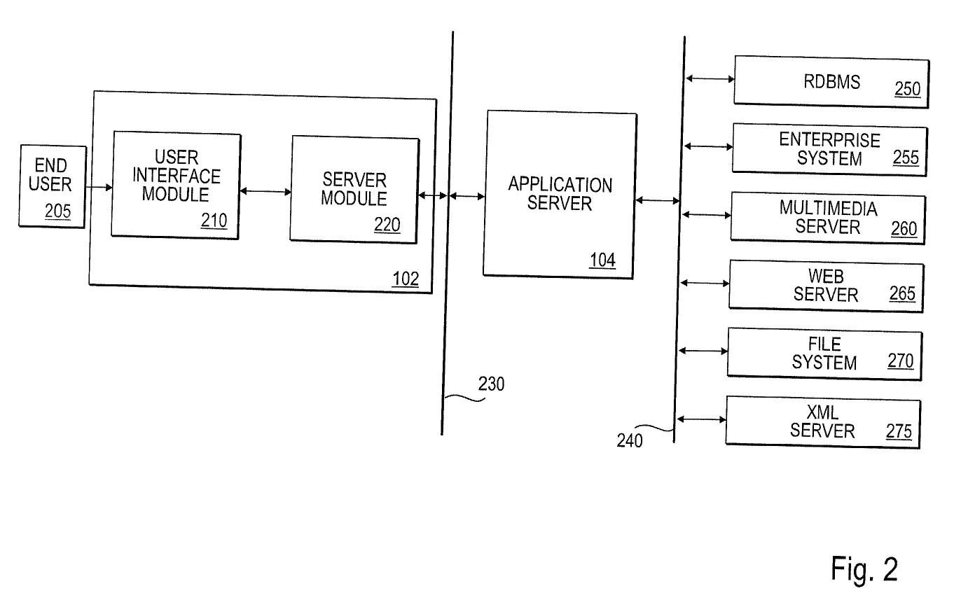

FIG. 2 is a block diagram of one embodiment for the network including a system for integrating multiple applications. As illustrated in FIG. 2, in one embodiment, application server 104 is connected to client 102 via bus 230. Alternatively, server 104 may be connected to multiple clients 102 via a WAN 100. Client 102 further includes a user interface module 210 coupled to a processing module 220.

End users, for example end user 205, interact with client 220 via user interface module 210. In one embodiment, end user 205 interacts with the user interface module 210 within client 102 through a browser (not shown) and WAN 100. Alternatively, end user 205 may interact with user interface module 210 directly or through any connection of a number of known types of connections.

In one embodiment, application server 104 is also connected to several data sources 250-275 via bus 240. Alternatively, server 104 may be connected to the data sources via WAN 100. In one embodiment, the data sources may include for example a relational database module (RDBMS) 250, an enterprise system 255, a multimedia server 260, a web server 265, a file system 270, and/or an XML server 275. Alternatively, server 104 may be connected to any of a variety of additional data sources. In one embodiment, the data sources 250-275 reside in storage device 106. Alternatively, the data sources may reside on disparate storage mediums.

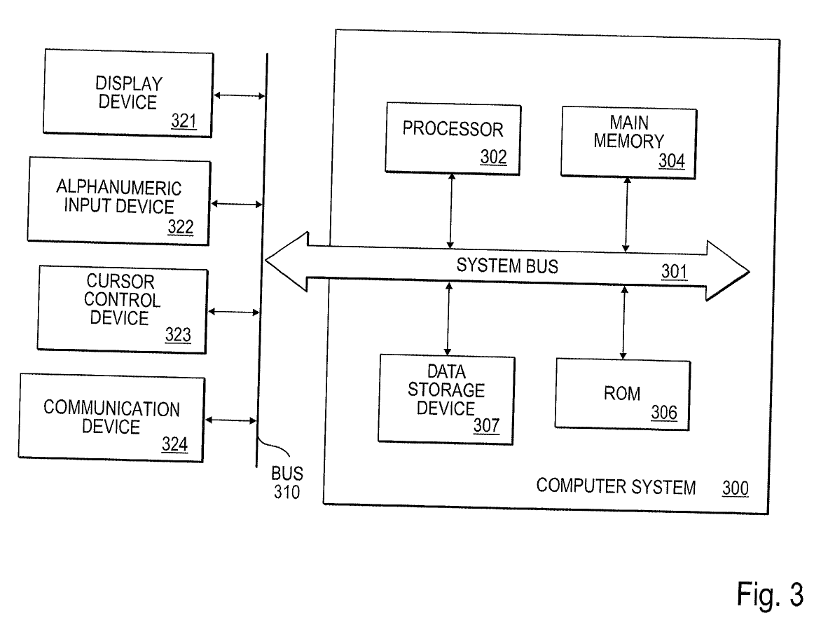

Having briefly described one embodiment of the network environment in which the present invention operates, FIG. 3 shows an example of a computer system 300 illustrating an exemplary client 102 or server 104 computer system in which the features of the present invention may be implemented.

Computer system 300 includes a system bus 301, or other communications module similar to a system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

Computer system 300 also includes a read only memory (ROM) 306, and/or other similar static storage device, coupled to bus 301, for storing static information and instructions for processor 302.

An optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

Alternatively, the client 102 can be implemented as a network computer or thin client device, such as the WebTV Networks™ Internet terminal or the Oracle™ NC. Client 102 may also be a laptop or palm-top computing device, such as the Palm Pilot™. Such a network computer or thin client device does not necessarily include all of the devices and features of the above-described exemplary computer system. However, the functionality of the present invention may nevertheless be implemented with such devices.

A communication device 324 is also coupled to bus 310 for accessing remote computers or servers, such as server 104, or other servers via the Internet, for example. The communication device 324 may include a modem, a network interface card, or other well known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

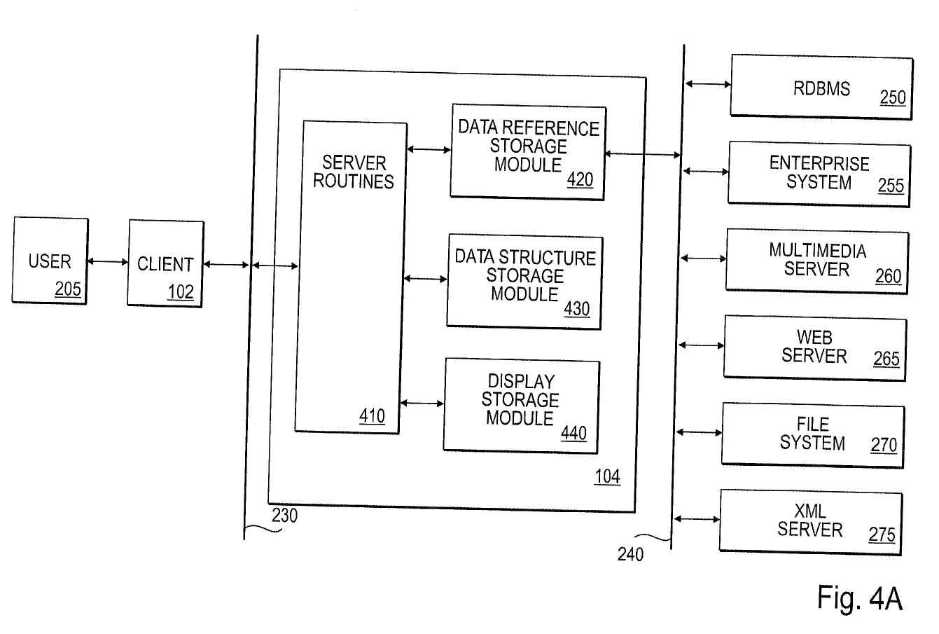

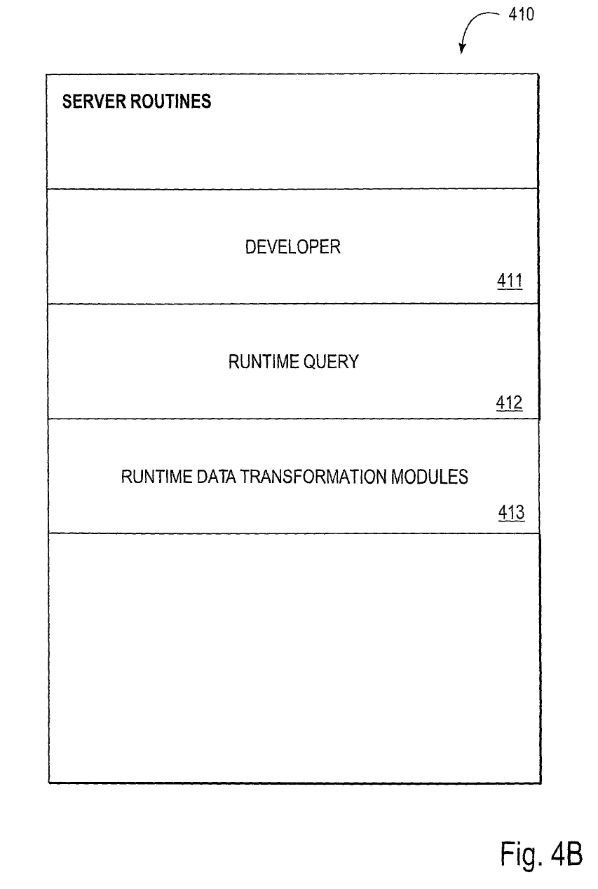

FIG. 4A is a block diagram of one embodiment for a server 104 within the network illustrated in FIG. 1. As illustrated in FIG. 4A, in one embodiment, server 104 includes server routines 410 coupled to bus 230, a data reference storage module 420 coupled to server routines 410 and bus 240, and data structure storage module 430 and display storage module 440 coupled to server routines 410.

In one embodiment, server routines 410 interact with client 102 to create one or more data reference structures stored within data reference storage module 420, one or more data structures stored within data structure storage module 430, and one or more display pages stored within display storage module 440.

In one embodiment, data is retrieved from the connected data sources 250-275, for example relational database module (RDBMS) 250, enterprise system 255, multimedia server 260, web server 265, file system 270, and/or XML server 275 shown in FIG. 2. Alternatively, data may be retrieved from any of a number of additional servers. Data is retrieved and parsed to create a standard form of data that may be used by the server routines 410. For example, portions of a web page may be extracted between a set of HyperText Markup Language (HTML) tags or by extracting hyperlinks within the web page.

In one embodiment, server routines interact with client 102 to create data reference structures stored within module 420. Data reference structures interact with the connected data sources and/or servers to provide data to server routines 410.

Data reference structures define ways to locate and connect to data within the data sources 250-275. In one embodiment, each data reference structure is an object that specifies the source connection information to data. For example, one data reference structure may be defined to access a relational database located locally or on a remote server, such as RDBMS 250 shown in FIG. 2. Alternatively, other data reference structures may be a flat file, a web file, or an XML document, designed to connect to file system 270, web server 265, or XML server 275, respectively. In one embodiment, user 205 may define one or more data reference structures using a data reference editor (not shown) residing within user interface module 210 of client 102.

In one embodiment, server routines 410 interact with client 102 to create a number of data structures from the accessed data, the data structures being stored within module 430. In one embodiment, each data structure is a meta object.

In one embodiment, each data structure or meta object refers to one or more data reference structures and includes metadata that defines the data to be accessed, specifies a set of operations to be performed on the data, and defines logic to be applied when data is retrieved from the accessed data source. In an alternate embodiment, some data structures, labeled abstract data structures may be created without a reference to a data reference structure. In one embodiment, the specified set of operations includes SQL operations and operations to query, insert, update, and delete data.

Compound data structures are data structures created from other data structures. In one embodiment, the set of operations specified for the compound data structures does not support the insert, update, and delete operations. In one embodiment, once created, each data structure is reusable and may be used by different users 205 for different queries and to extract data from the data sources 250-275. In one embodiment, user 205 may create data structures using a data structure editor (not shown) residing within the user interface module 210 of client 102.

In one embodiment, server routines 410 receive data, for example HTML pages, from one of the connected data sources 250-275, for example RDBMS 250 or web server 265. Server routines 410 then parse the data to create a topographical or spatial representation of the data, for example a tree structure. Client 102 then interacts with server routines 410 to manipulate the topographical or spatial representation to create relationships or tags between various nodes of the representation, and further to create the data structure or meta object associated with the received data, which references the corresponding data sources. Each data structure represents a new hierarchical representation of the tagged data.

In one embodiment, data is individually parsed, for example each HTML page is parsed separately. Alternatively, multiple sources of data may be parsed together. In one embodiment, the data structure is then stored within the data structure storage module 430.

In one embodiment, server routines 410 interact with client 102 to create a number of display pages or views to be stored within the display storage module 440. In one embodiment, the display pages are Java Server Page (JSP) views. Each JSP view is a dynamic page, for example an HTML page, containing special tags interpretable by server 104. Alternatively, the display pages may be Extensible Markup Language (XML) views. Each XML view is an XML document containing data to be displayed on client 102.

In one embodiment, user 205 interacts with client 102 to create the display pages. User 205 generates tags and text using an external editor (not shown) and adds the tags and text to the display pages.

FIG. 4B is a lock diagram of one embodiment for server routines within the server 104. As illustrated in FIG. 4B, in one embodiment, server routines 410 may be maintained within main memory 304 of a server 104, as shown in FIG. 3. Server routines 410 include developer 411, runtime query 412 and runtime data transformation modules 413. Developer 411 interacts with client 102 to create the data reference structures and the data structures. Runtime query 412 contains software routines for retrieving the stored data structures from the data structure storage module 430 and for retrieving data from the data sources 250-275. The software routines within the runtime query 412 also send data to client 102. Runtime data transformation modules 430 receive data and transform a variety of data components, for example HTML pages or text documents, into a form suitable for display on client 102.

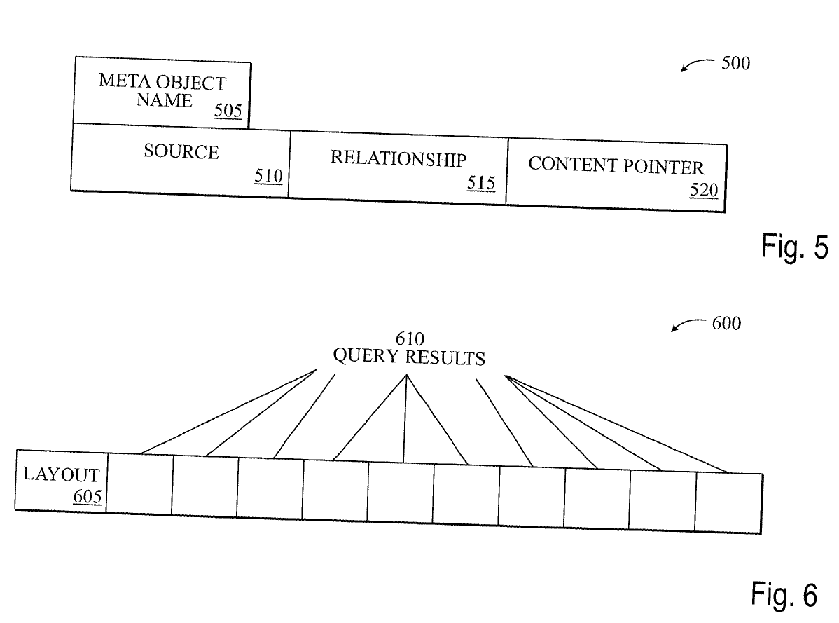

FIG. 5 is a block diagram of one embodiment for a data structure. As illustrated in FIG. 5, data structure or meta object 500 includes meta object name 505, data source 510, relationship 515, and content pointer 520. In one embodiment, meta object name 505 is a unique name given to data structure or meta object 500 by the user 205 during creation of the data structure. Data source field 510 indicates the source of data utilized to create the data structure. Data source field 510 may, for example, reference web server 265 or RDBMS 250, or any other database or server. Relationship 515 contains the relationships developed between data structures 500. In one embodiment, data structure 500 may include content pointer 520, which points to an optional content source.

In one embodiment, data structure 500 may include a logic component or a collection of associated logic components. The logic component associated with data structure 500 is executable program code that is executed on the data structure after a query is executed. The logic component may perform calculations on query results or manipulate the query results. The query will be described in further detail below.

In one embodiment, user 205 may enter logic component code in a suitable programming language. The entered logic component code becomes the logic component that may be executed at runtime after the data structure has been executed.

FIG. 6 is a block diagram of one embodiment for a query. As illustrated in FIG. 6, query 600 includes query layout 605 and a number of query results 610. Query layout 605 contains information for displaying data structures 500 on client 102. Query results 610 contain information concerning the current state of data to be displayed on client 102. Query results 610 are retrieved from a data source 250-275, for example RDBMS 250 or web server 265, and data is then displayed on client 102.

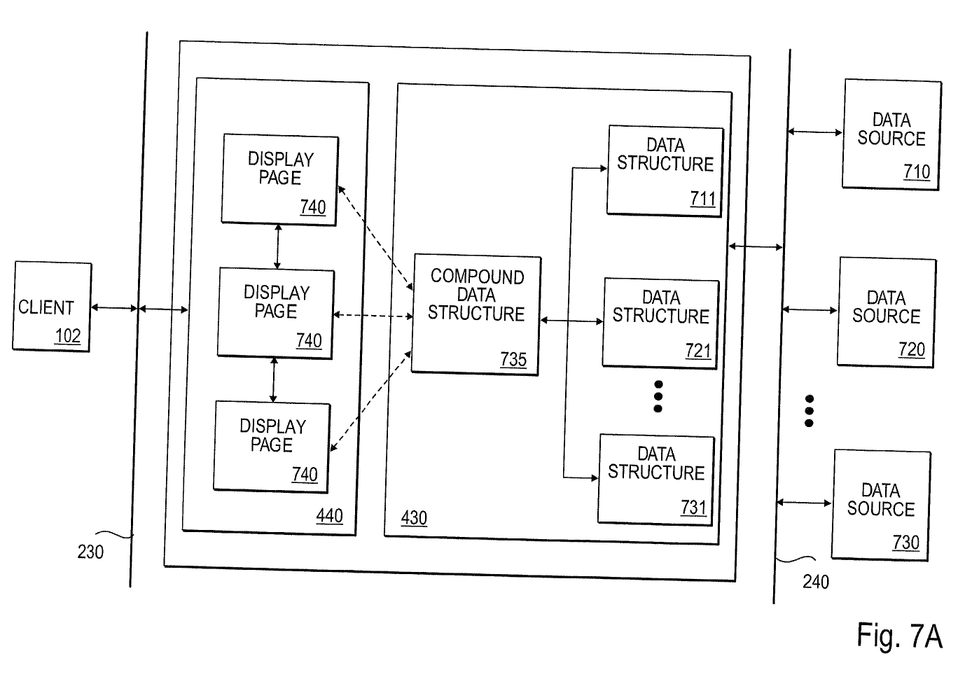

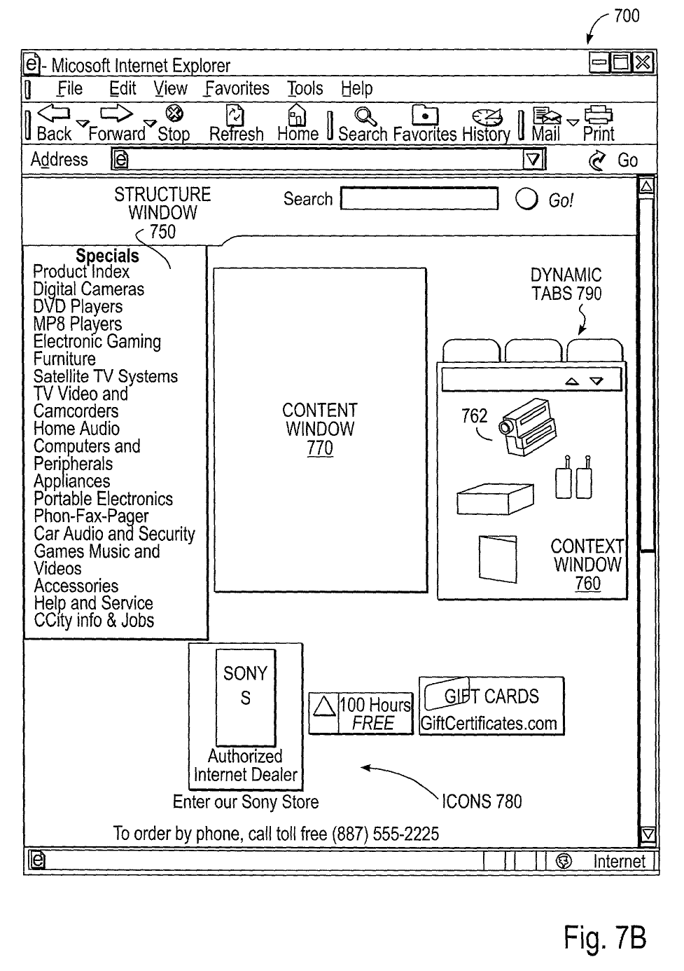

FIG. 7A is a block diagram of one embodiment for a system for integrating multiple applications. As illustrated in FIG. 7A, server 104 is connected via bus 240 to multiple data sources, of which data sources 710, 720, and 730 are shown. In one embodiment, data sources 710 through 730 are situated on different levels of a chain, for example a supply chain. Alternatively, data sources 710-730 may be situated on the same level of the chain. In one embodiment, data sources 710-730 are disparate contributors to an end product and provide information relating to the end product.

In one embodiment, data structure storage module 430 within server 104 includes multiple data structures, of which data structures 711, 721, and 731 are shown. In one embodiment, data structure 711 is connected and corresponds to data source 710, located on a predetermined level of the supply chain. Similarly, data structures 721 and 731 are connected and correspond to data sources 720 and 730, respectively. Alternatively, each data source 710-730 may be connected to multiple data structures 711-731.

In one embodiment, data structure storage module 430 further includes a compound data structure 735. The compound data structure 735 is created from and refers to each data structure 711 through 731. Alternatively, multiple compound data structures 735 may be created from the multiple data structures 711-731, each compound data structure 735 corresponding to a different combination of data structures. In one embodiment, compound data structure 735 receives information relating to the end product from the storage devices 710-730 located on different levels of the chain. The compound data structure 735 is configured to link and match the product information and to transmit the information to client 102.

In one embodiment, display storage module 440 within server 104 includes multiple display pages 740 referencing the compound data structure 730 and data structures 711 through 731. Alternatively, display pages 740 may only reference the compound data structure 735 or may reference each other.

In one embodiment, the supply chain is a retailer/manufacturer chain having a retailer level and multiple manufacturer levels. In one embodiment, data source 710 is a relational database, which contains data within multiple tables. Data source 710 is situated at the retailer level and includes multiple data items, for example data related to products available at the retailer level, such as lists of product categories, lists of products and prices for the products, and lists of the product sources, for example the product manufacturers. Alternatively, retailer data source 710 may be any of a variety of data sources, for example a web server, a file server, or an enterprise system.

In one embodiment, data sources 720 and 730 are HTML sources, for example web servers. Data sources 720 and 730 are situated at the manufacturer levels within the retailer/manufacturer chain. Each data source 720 and 730 stores multiple data items, for example data related to products manufactured by the corresponding manufacturer, such as names and images of the products, and descriptions of the products. Alternatively, data sources 720 and 730 may be any of a variety of additional servers or databases.

In one embodiment, data structure 711 is connected and corresponds to the retailer data source 710. Data structures 721 and 731 are connected and correspond to manufacturer data sources 720 and 730, respectively. Alternatively, each data source may be connected to multiple data structures.

In one embodiment, data structure 711 includes metadata, which defines data related to the products and prices available within the retailer data source 710. Data structure 721 includes metadata, which defines data related to the names, images, and descriptions of products within manufacturer data source 720. Similarly, data structure 731 includes metadata, which defines data related to the names, images, and descriptions of products within manufacturer data source 730. In one embodiment, compound data structure 735 is created from data structures 711, 721, and 731 to link and match data items stored within data source 710, for example products and prices, with data items stored within data sources 720 and 730, for example respective names, images, and descriptions of the products.

In one embodiment, after initialization, client 102 connects to server 104 and transmits a request to retrieve information stored within the retailer storage device 710. Runtime query 412 retrieves the retailer data structure or meta object 711 from module 430 and queries the data source field 510 to return current data for the data structure 500 into query results 610. Runtime query 412 places retrieved data in layout 605 and transmits the query results 610 to client 102 for display in a display page 740. Alternatively, using a similar procedure, client 102 may request and receive information stored within manufacturer storage devices 720 and 730, as described in further detail below.

In an alternate embodiment, the supply chain is a manufacturer/supplier chain having a manufacturer level and multiple supplier levels. In one embodiment, data source 710 is a relational database located at the manufacturer level in the manufacturer/supplier chain. Data source 710 includes multiple data items, for example data related to end products manufactured at the manufacturer level, such as end product lists and prices.

In one embodiment, data sources 720 and 730 are HTML sources, for example web servers. Data sources 720 and 730 are situated at the supplier levels within the manufacturer/supplier chain. In one embodiment, each data source 720 and 730 stores multiple data items, for example data related to each end product, such as names and images of parts or components manufactured for the end product, as well as a description of each component. Alternatively, data sources 720 and 730 may be any of a variety of additional servers or databases and may store any other type of data related to the end product.

In one embodiment, compound data structure 735 receives information from manufacturer data source 710 and supplier data sources 720 and 730, located on different levels of the supply chain, and matches the end product information received from data source 710 with information related to the end products received from data sources 720 and 730. In one embodiment, data source 710 is a manufacturer of end products and supplies information about the products and prices. In one embodiment, data source 720 is a supplier, for example a supplier of components for the end products and transmits information about the name, image, and description of the components. In one embodiment, data source 730 is a supplier on a different level of the supply chain, for example a supplier of compliance specification related to the parts or components, such as a governing agency.

FIG. 7B illustrates an exemplary display window (or user interface) 700 for the system. In one embodiment, user 205 may access the display window 700 within client 102 by moving a pointing device, for example a mouse, over window 700 and/or clicking on certain areas of window 700.

As illustrated in FIG. 7B, in one embodiment, display window 700 includes a structure window 750, a context window 760, and a content window 770. In one embodiment, display window 700 also includes one or more icons 780 providing electronic links to various entities, for example manufacturers of the products available at different levels in the supply chain or advertisers. Alternatively, display window 700 may include any of a number of additional windows 750-770 and icons 780. In one embodiment, window 700 further includes dynamic tabs 790, which are interactive tabs that depend on the user selections. In one embodiment, user 205 may access any window within display window 700.

In one embodiment, the structure window 750, context window 760, and content window 770 within display window 700 are interactive. User 205 may change the content of the context window 760 and the dynamic tabs 790 by accessing the structure window 750, for example with a mouse click. User 205 may also change the content of the content window 780 by accessing the context window 760, for example with a mouse click.

In one embodiment, when a display page loads, several tasks may be performed in the background. A browser of the user 205 is first enabled by an applet embedded within the display page 740. The applet allows the user to view the initial display page 740 in its current state, without any user intervention.

In one embodiment, user 205 interacts with client 102 and transmits a request to retrieve data stored in a data source, for example data source 710. Runtime query 412 retrieves the data structure or meta object 711 from module 430 and queries data source field 510 to return current data for the data structure 500 into query results 610. Runtime query 412 places retrieved data in layout 605 and transmits the query results 610 to client 102 for display in the display page 740.

In one embodiment, data within the display page 740 populates structure window 750 and includes a list of product categories available from the particular retailer within a retailer/manufacturer chain. Alternatively, data may include a list of products available from the retailer. In an alternate embodiment, other types of data may be displayed within structure window 750, for example data related to end products manufactured at the manufacturer level of a manufacturer/supplier chain, for example lists of product categories and products. In one embodiment, the content of the structure window 750 is transmitted in real time from the retailer.

In one embodiment, if user 205 wants to access product information, he selects a particular product by clicking on a product category within structure window 750. The request is transmitted to server 104. Runtime query 412 retrieves data structures 721 and 731 from module 430 and queries the respective data source fields 510 to return current data from data sources 720 and/or 730. Runtime query then returns data to client 102 for display.

In one embodiment, retrieved data populates the context window 760 of window 700 and includes names and images of products stored within manufacturer data sources 720 and/or 730 within the retailer/manufacturer chain. Alternatively, context window 760 may display other product data, for example a rating for each particular product. In an alternate embodiment, other types of data may be displayed within context window 760, for example data related to parts or components for each end product manufactured at the supplier level in the manufacturer/supplier chain, for example names and images of the components.

In one embodiment, context window 760 is a banner having content consisting of image, model name, and rating of each product. Alternatively, the banner may have content consisting of image, model name, and description of each part or component of the end product.

In one embodiment, the content of the banner may have a scrolling-type motion, for example the content may move in a vertical direction. Alternatively, the content of the banner may move in any direction within the context window 760. In one embodiment, the content of the context window 760 is transmitted in real time from the manufacturer.

In one embodiment, data within context window 760 may be rendered in frames 762, each frame 762 representing a different product. Each frame 762 moves within context window 760 without any interaction on the part of the user 205. In one embodiment, each frame 762 is transmitted in real time.

In one embodiment, if user 205 wants to select one product displayed within context window 760, he selects a frame 762 of the product by clicking on the frame 762. If a frame 762 is accessed, for example with a conventional mouse click, the request is transmitted to server 104. Runtime query 412 retrieves a data structure 721 or 731 from module 430 and queries the respective data source field 510 to return current data from the data source 720 or 730. At the same time, runtime query 412 retrieves the data structure 711 from module 430 and queries the respective data source field 510 to return current data from the data source 710. In one embodiment, after data is returned from all data sources 710-730, the runtime query 412 retrieves the compound data structure 735 to link and match the returned data into a composite item. In one embodiment, each product and price from the data storage 710 is matched with the corresponding name, image, and description from the storage device 720 or 730 and with any other information available.

In one embodiment, data retrieved populates the content window 770 within window 700 and includes an image, name, and description of the product selected, which are retrieved from the manufacturer data source 720 or 730, and the price of the product, which is retrieved from the retailer data source 710. In an alternate embodiment, other types of data may be displayed within content window 770, for example an image, name, and description of the part or component, which are retrieved from supplier data source 720, for example a component manufacturer, and compliance information related to the component, which is retrieved from supplier data source 730, for example a governing agency. In one embodiment, the content within content window 770 is transmitted in real time from the manufacturer and the retailer.

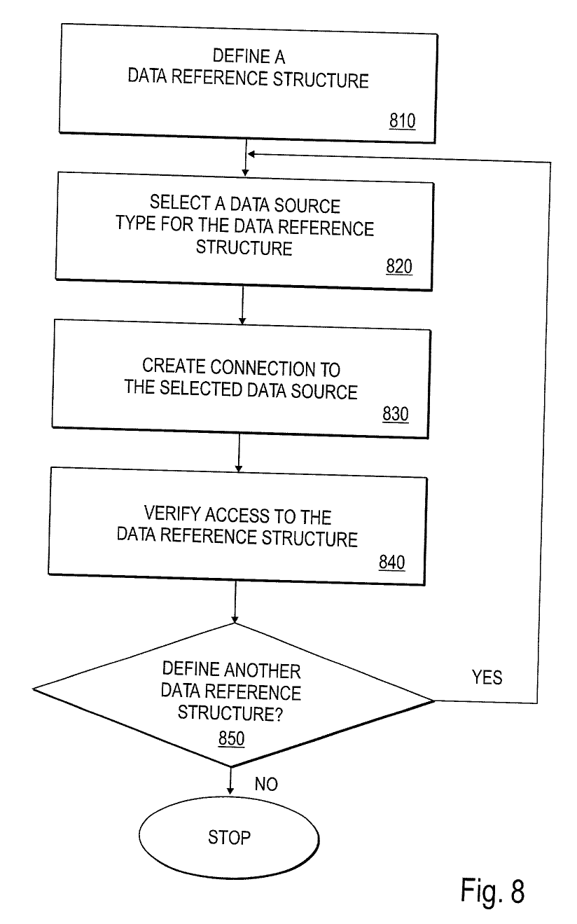

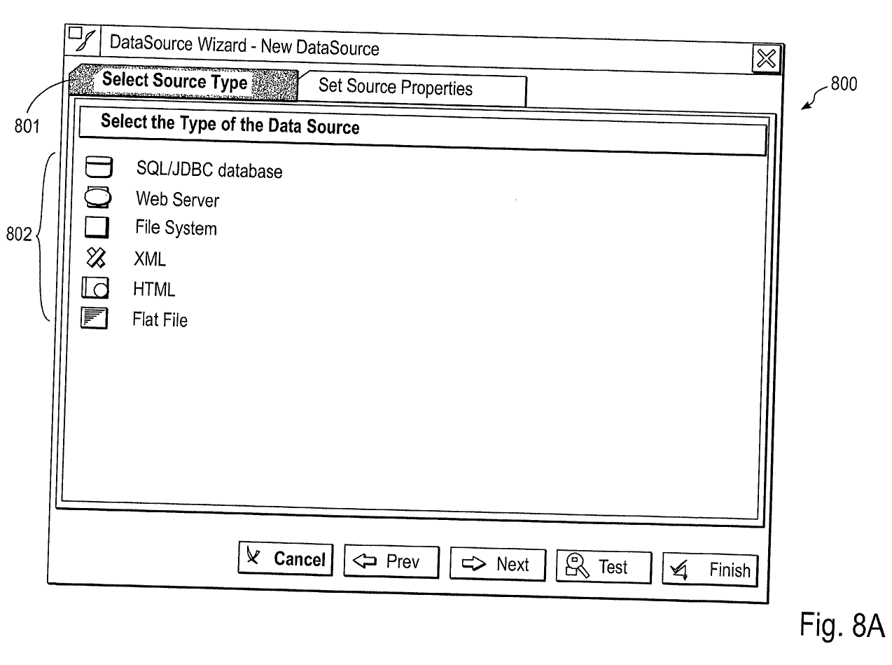

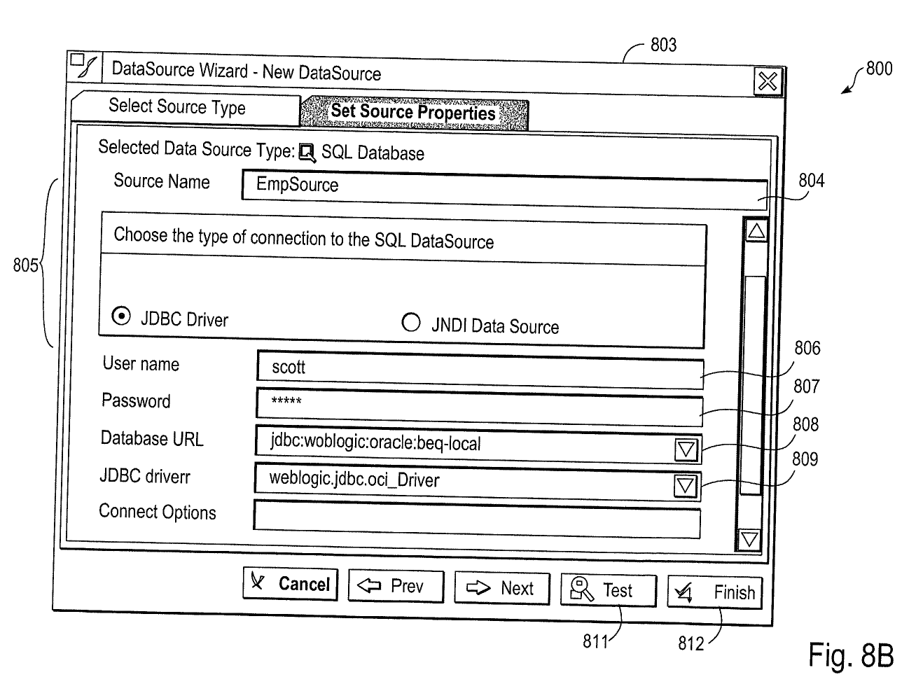

FIG. 8 is a flow diagram of one embodiment for a method for creating data reference structures within server 104. FIGS. 8A-8B illustrate exemplary interfaces to create the data reference structures.

As illustrated in FIG. 8, at processing block 810, a data source type is selected for a data reference structure to be defined. In one embodiment, user 205 selects the data source type for the data reference structure through a data reference editor within user interface module 210 of client 102.

Referring to FIG. 8A, in one embodiment, user 205 selects a Select Source Type tab 801 within a first user interface area, for example interface 800, with a conventional mouse click. Interface 800 displays a list 802 of available data source types for data sources 250-275. In one embodiment, list 802 contains a SQL/JDBC database type, a Web Server type, a File System type, an XML type, an HTML type, and a Flat File type. It is to be understood that other types of data sources may be included in list 802. Next, user 205 selects a type of data source from the list 802, for example the SQL/JDBC database.

As illustrated in FIG. 8, at processing block 820, the data reference structure is defined. In one embodiment, user 205 defines the data reference structure through the data reference editor within user interface module 210.

Referring to FIG. 8B, in one embodiment, user 205 selects a Set Source Properties tab 803 within interface 800 using a conventional mouse click command. Interface 800 displays multiple fields to allow user 205 to define the data reference structure.

In one embodiment, user 205 inputs a name for the data reference structure in a Source Name field 804 and chooses a type of connection to the selected data source in window 805 using a conventional mouse click command. For example user 205 selects the JDBC driver option within window 805.

As illustrated in FIG. 8, at processing block 830, a connection is created to the selected data source. In one embodiment, user 205 creates the connection to the data source 250-275 through the data reference editor within user interface module 210.

Referring to FIG. 8B, in one embodiment, user 205 interacts with interface 800 and inputs login information, such as a user name in the User Name field 806 and a password in the Password field 807. Then, user 205 selects a database URL from a drop-down menu displayed upon a mouse click request in the Database URL field 808.

Subsequently, user 205 inputs information regarding the type of connection selected in a JDBC Driver field 809 using a drop-down menu displayed upon a mouse click request. In one embodiment, user 205 inputs the selected JDBC driver information in field 809.

As illustrated in FIG. 8, at processing block 840, access to the data reference structure and the connection to the data source are verified. In one embodiment, user 205 verifies access to the data reference structure and the connection to the data source 250-275 through the data reference editor within user interface module 210.

Referring to FIG. 8B, in one embodiment, user 205 presses a Test button 811 within interface 800 with a mouse click to verify access to the data reference structure. Then, user 205 presses the Finish button 812 within interface 800 to exit the process.

As illustrated in FIG. 8, at processing block 850, a decision is made whether another data reference structure needs to be defined. If user 205 needs to access another data source 250-275, then another data reference structure needs to be defined for the specific data source and processing blocks 810 through 840 are repeated. In one embodiment, user 205 repeats the steps associated with processing blocks 810-840 and communicates with the data reference editor to create the new data reference structure. Otherwise, if no other data reference structure needs to be defined, the procedure stops.

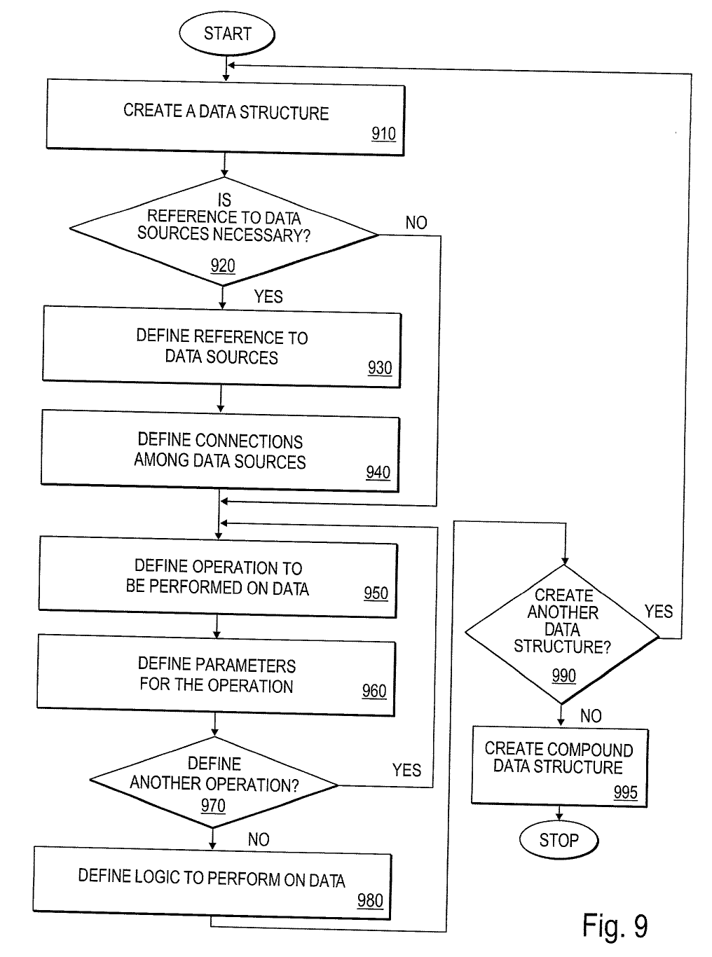

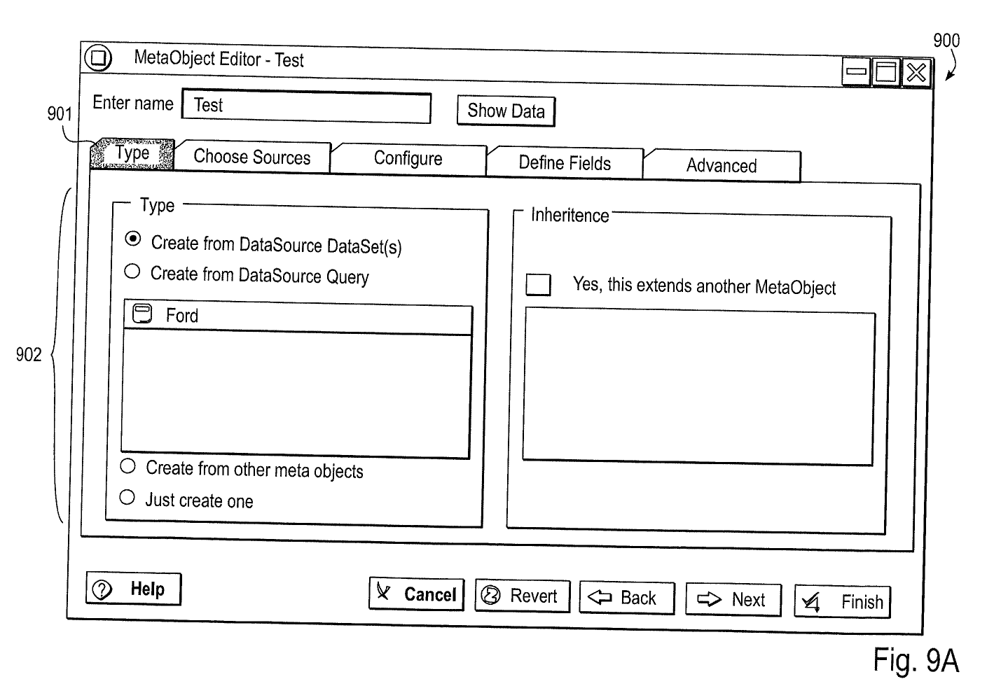

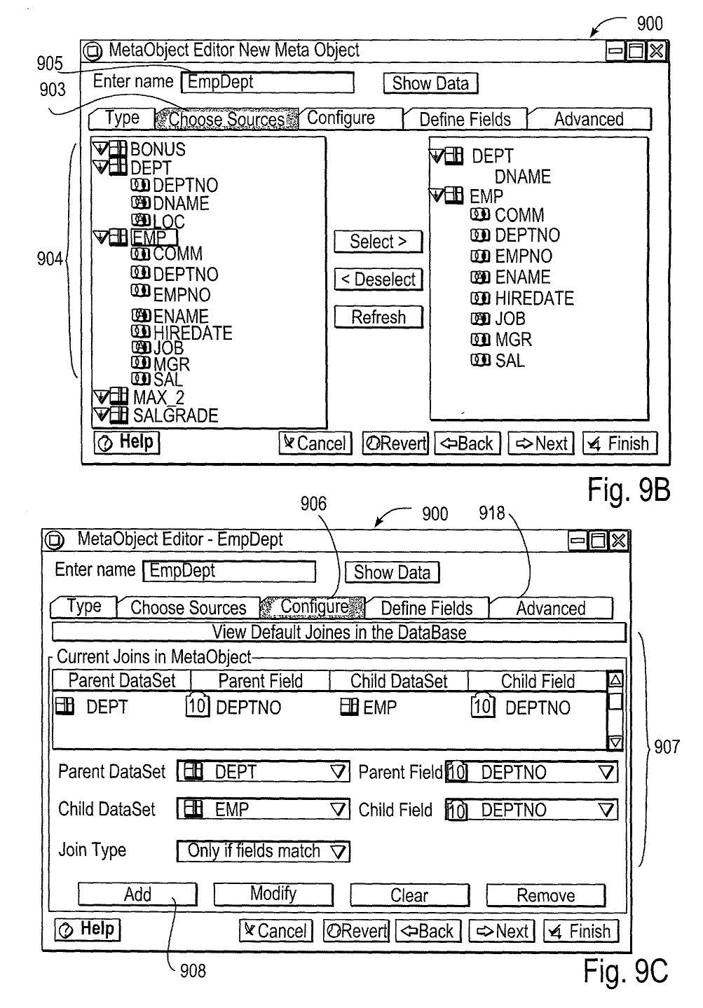

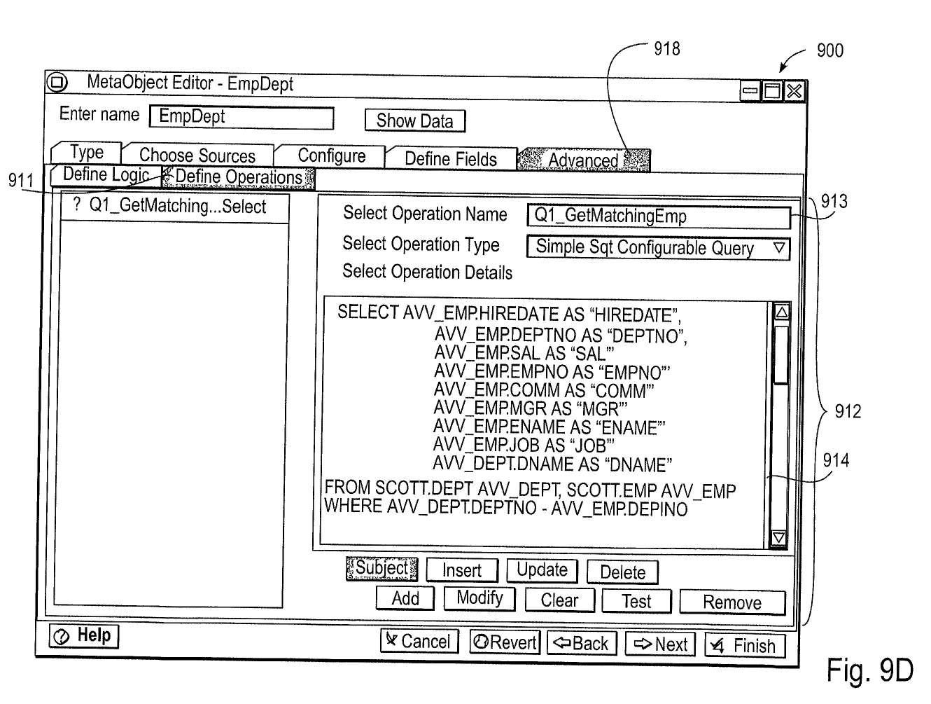

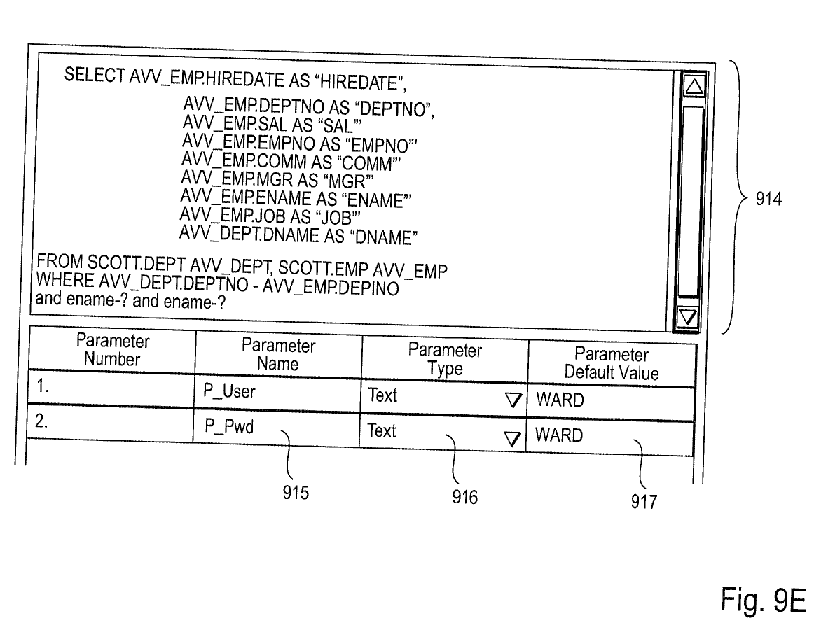

FIG. 9 is a flow diagram of one embodiment for a method for creating data structures within the server 104. FIGS. 9A-9E illustrate exemplary interfaces to create the data structures.

As illustrated in FIG. 9, at processing block 910, a data structure is created. In one embodiment, user 205 creates a data structure through a data structure editor within user interface module 210 of client 102.

Referring to FIG. 9A, in one embodiment, user 205 selects a Type tab 901 within a second interface area, for example interface 900, with a conventional mouse click. Interface 900 displays a window 902 allowing selection of a data structure type for the data structure. Then, user 205 selects one option within window 902 using a mouse click command. In one embodiment, user 205 selects the Create from Data Source Dataset(s) option within window 902.

Referring to FIG. 9B, in one embodiment, user 205 selects a Choose Sources tab 903 within interface 900 with a conventional mouse click. Interface 900 displays a window 904 containing a list of data sources accessible through user interface module 210. In one embodiment, user 205 enters a name for the data structure in a field 905 within interface 900.

As illustrated in FIG. 9, at processing block 920, a decision is made whether a reference to the data sources is necessary within the data structure. If a reference to the corresponding data sources 250-275 is not necessary, the procedure jumps to processing block 950. Otherwise, if a reference to data sources is necessary, at processing block 930, the reference to the data sources is defined. In one embodiment, user 205 defines a reference link, which illustrates a reference to the data sources, through the data structure editor within user interface module 210.

Referring to FIG. 9B, in one embodiment, user 205 selects one or more data sources 250-275 from the list of data sources displayed within window 904. Using a conventional mouse click command, user 205 presses a Select button within window 904 to define a reference link to each selected data source 250-275.

As illustrated in FIG. 9, at processing block 940, connections among the selected data sources are defined. In one embodiment, user 205 defines the connections among the data sources through the data structure editor within user interface module 210.

Referring to FIG. 9C, in one embodiment, user 205 selects a Configure tab 906 within interface 900 with a mouse click. Interface 900 displays multiple fields to allow user 205 to define the connections among the selected data sources 250-275.

In one embodiment, user 205 selects the connections from data structure connection fields 907 displayed within interface 900. In one embodiment, the data structure connection fields 907 are drop-down lists accessible through mouse click commands and containing alternative connections among the selected data sources. Subsequently, user 205 presses an Add button 908 within interface 900 to connect the selected data sources 250-275.

As illustrated in FIG. 9, at processing block 950, an operation to be performed on data stored within the selected data sources is defined. In one embodiment, user 205 defines the operation to be performed on data through the data structure editor within user interface module 210.

Referring to FIG. 9D, in one embodiment, user 205 selects an Advanced tab 918 within interface 900 with a mouse click. Further, user 205 selects a Define Operations tab 911 within interface 1000. In one embodiment, interface 900 displays a window 912 containing multiple fields, which allow user 205 to define an operation to be performed on the data, for example a query to retrieve data stored in the selected data sources 250-275.

In one embodiment, user 205 inputs a name for the defined operation in a Select Operation Name field 913 within window 912. Next, user 205 selects an operation type from a drop-down list within window 912 using a conventional mouse click command. Interface 900 displays a statement for the selected operation in a Select Operation Details field 914 within window 912.

As illustrated in FIG. 9, at processing block 960, parameters are defined for the selected operation. In one embodiment, user 205 defines one or more parameters, for example query parameters, for the selected operation or query through the data structure editor within user interface module 210.

Referring to FIG. 9E, in one embodiment, user 205 appends language designed to define the query parameters within the statement displayed in field 914. As a result, interface 900 displays multiple parameter fields to allow user 205 to define each query parameter of the requested parameters for the selected query.

In one embodiment, user 205 inputs the name of the defined parameters in a Parameter Name field 915 and chooses a parameter type for each defined parameter from a drop-down list displayed within a Parameter Type field 916. Finally, user 205 inputs a default value for each defined parameter in a Parameter Default Value field 917.

As illustrated in FIG. 9, at processing block 970, a decision is made whether to define another operation within the data structure. If another operation needs to be defined within the data structure, processing blocks 950 through 960 are repeated. In one embodiment, user 205 repeats the steps associated with processing blocks 950, 960 and communicates with the data structure editor within user interface module 210 to define another operation.

Otherwise, at processing block 980, a logic component to be performed on retrieved data is defined. In one embodiment, user 205 interacts with the data structure editor within user interface module 210 and defines the logic component to be performed on the retrieved data. In one embodiment, one data structure is created for each data source connected to server 104.

At processing block 990, a decision is made whether another data structure needs to be created. If another data structure needs to be created, then processing blocks 910 through 980 are repeated.

Otherwise, if no new data structure needs to be created, at processing block 995, a compound data structure is created. In one embodiment, user 205 interacts with user interface module 210 within client 102 to create the compound data structure from the already created data structures. In one embodiment, the compound data structure creates relationships among the data structures and supports the operations and logic defined for the data structures. Alternatively, multiple compound data structures may be created from the already existent data structures. In one embodiment, user 205 uses the data structure editor within the user interface module 210 to create the compound data structure.

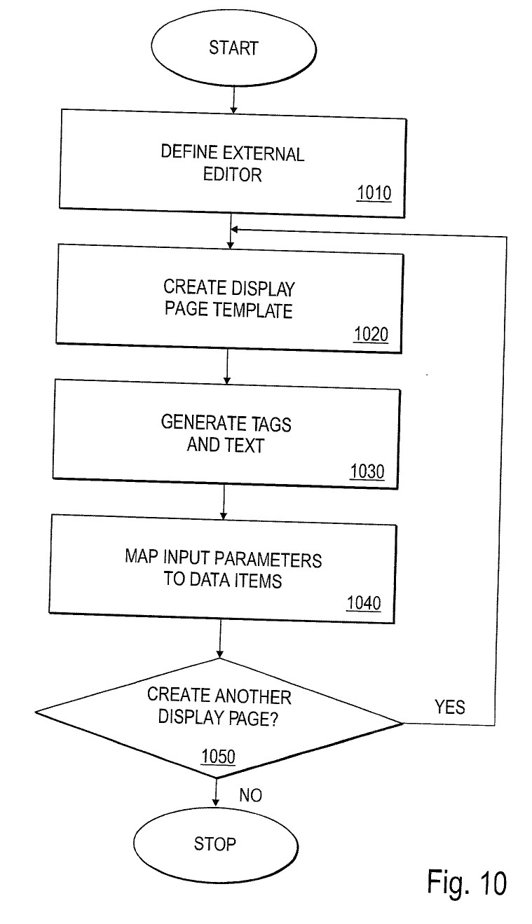

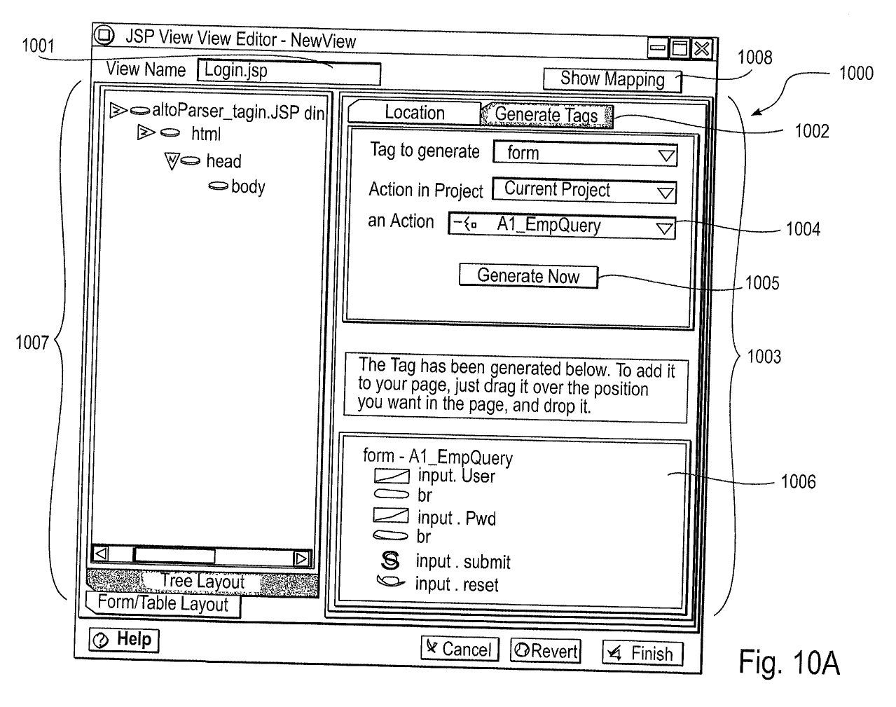

FIG. 10 is a flow diagram of one embodiment for a method for creating a display page within the server. FIG. 10A is an exemplary interface to create the display page.

As illustrated in FIG. 10, at processing block 1010, an external editor is defined. In one embodiment, user 205 defines the external editor through user interface module 210 within client 102. User 205 types a path to the external editor in a window displayed by user interface module 210 in the user browser. In one embodiment, the external editor is used to create and/or modify HTML code for display pages.

At processing block 1020, a display page template is created. In one embodiment, user 205 creates display page template through a display page editor within user interface module 210.

Referring to FIG. 10A, in one embodiment, user 205 creates the display page template using interface 1000. User 205 inputs a name for the display page, for example an HTML page, in a View Name field 1001 within interface 1000. In one embodiment, in order to populate the HTML display page template with text and tags, user 205 uses the previously defined external editor.

In one embodiment, a window 1007 within interface 1000 displays a structure for the HTML display page template, for example a tree structure, containing multiple nodes, for example a head node and a body node.

As illustrated in FIG. 10, at processing block 1030, text and tags are generated for the display page template. In one embodiment, user 205 inputs the text and generates the tags through the display page editor within user interface module 210.

Referring to FIG. 10A, in one embodiment, user 205 selects a Generate Tags tab 1002 within interface 1000. Interface 1000 displays a window 1003 to allow user 205 to generate the tags, which enable the display page to write dynamic data.

In one embodiment, user 205 selects an action with a conventional mouse click from a Trigger an Action drop-down list 1004 and presses a Generate Now button 1005 with another mouse click to generate a tag. In one embodiment, parameters for the generated tag are displayed in a window 1006.

As illustrated in FIG. 10, at processing block 1040, input parameters are mapped to data items from the accessed data source. In one embodiment, user 205 maps input parameters in the display page template to the data items through the display page editor within user interface module 210.

Referring to FIG. 10A, in one embodiment, user 205 drags the generated tag displayed in window 1006 and drops it on a node displayed within window 1007, for example the body node. Next, user 205 expands the body node with a conventional mouse click to display the generated tag within window 1007 and presses a Show Mapping button 1008 within interface 1000 to map the input from the display page to the data item.

As illustrated in FIG. 10, at processing block 1050, a decision is made whether another display page needs to be created. If another display page needs to be created, processing blocks 1010 through 1040 are repeated. In one embodiment, user 205 repeats the steps associated with processing blocks 1010 through 1040 and communicates with the display page editor within user interface module 210 to create another display page. Otherwise, if no other display page needs to be created, the procedure stops.

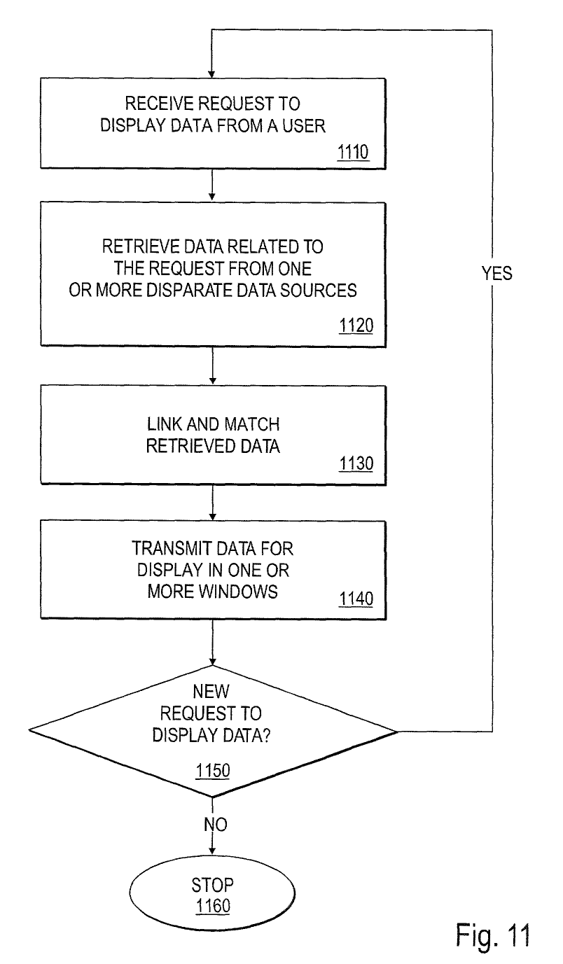

FIG. 11 is a flow diagram of one embodiment for a method for integrating multiple applications. As illustrated in FIG. 11, at processing block 1110, a request to display data is received from a user. In one embodiment, the user 205 requests presentation of data pertaining to an item collected from multiple disparate data sources 250-275. The item is a composite item having multiple components, each component of the composite item relating to a data item stored within one or more of the disparate data sources 250-275.

At processing block 1120, data related to the request is retrieved from one or more disparate data sources. In one embodiment, multiple data items related to the request are retrieved from the disparate data sources, each data item pertaining to a distinct aspect of the item. In one embodiment, the disparate data sources are geographically disposed and coupled to a common network.

At processing block 1130, the data retrieved from the disparate data sources 250-275 is linked and matched. In one embodiment, the data items retrieved are linked and matched to form the composite item to be presented to the user.

Next, at processing block 1140, data is displayed in one or more windows for the user. In one embodiment, data contained in the composite item is displayed in a display page for the user.

In one embodiment, at processing block 1150, a decision is made whether a new request to display data has to be processed. If a new request has to be processed, processing blocks 1110 through 1140 are repeated. Otherwise, procedure ends at processing block 1160.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An automated method to present data pertaining to an item collected from a plurality of disparate data sources, the method comprising:
retrieving a plurality of data items related to a request from a user from said plurality of disparate data sources, each data item of said plurality of data items pertaining to a distinct aspect of said item; and
displaying said plurality of data items in at least one window for said user.

2. The method according to claim 1, wherein said plurality of disparate data sources are geographically disposed and coupled to a common network.

3. The method according to claim 1, wherein said item is a composite item, and each data item of said plurality of data items pertains to a component of said composite item.

4. The method according to claim 1, wherein each data source of said plurality of disparate data sources comprises an original publisher of a corresponding data item of said plurality of data items.

5. The method according to claim 1, wherein each data source of said plurality of disparate data sources is located on separate levels of a supply chain.

6. The method according to claim 1, wherein said plurality of data sources are disparate contributors to an end product.

7. The method according to claim 1, wherein said retrieving further comprises:
transmitting at least one query to said plurality of disparate data sources; and
retrieving at least one data item of said plurality of data items, said at least one data item being associated with each data source of said plurality of disparate data sources.

8. The method according to claim 7, further comprising:
receiving a plurality of input parameters within said request from said user; and
mapping said each input parameter of said plurality of input parameters to a query parameter of said at least one query, said query parameter residing within a data structure connected to one data source of said plurality of disparate data sources.

9. The method according to claim 8, wherein said data structure further references a data reference structure specifying a link to said one data source.

10. The method according to claim 5, wherein at least one data source of said plurality of disparate data sources is a retailer located within a retailer level of said supply chain.

11. The method according to claim 10, wherein a predetermined number of data sources of said plurality of disparate data sources are manufacturers of products located within separate manufacturer levels of said supply chain.

12. The method according to claim 5, wherein at least one data source of said plurality of disparate data sources is a manufacturer of an end product located within a manufacturer level of said supply chain.

13. The method according to claim 12, wherein a predetermined number of data sources of said plurality of disparate data sources are suppliers of components for said end product located within separate supplier levels of said supply chain.

14. The method according to claim 5, wherein at least one data source of said plurality of disparate data sources is a supplier of compliance information related to manufacture of an end product, said at least one data source being located within a supplier level of said supply chain.

15. The method according to claim 1, wherein each data item of said plurality of data items is displayed in real time.

16. A system to present data pertaining to an item collected from a plurality of disparate data sources, the system comprising:
means for retrieving a plurality of data items related to a request from a user from said plurality of disparate data sources, each data item of said plurality of data items pertaining to a distinct aspect of said item; and
means for displaying said plurality of data items in at least one window for said user.

17. The system according to claim 16, wherein said plurality of disparate data sources are geographically disposed and coupled to a common network.

18. The system according to claim 16, wherein said item is a composite item, and each data item of said plurality of data items pertains to a component of said composite item.

19. The system according to claim 16, wherein each data source of said plurality of disparate data sources comprises an original publisher of a corresponding data item of said plurality of data items.

20. The system according to claim 16, wherein each data source of said plurality of disparate data sources is located on separate levels of a supply chain.

21. The system according to claim 16, wherein said plurality of data sources are disparate contributors to an end product.

22. The system according to claim 16, further comprising:
means for transmitting at least one query to said plurality of disparate data sources; and
means for retrieving at least one data item of said plurality of data items, said at least one data item being associated with each data source of said plurality of disparate data sources.

23. The system according to claim 22, further comprising:
means for receiving a plurality of input parameters within said request from said user; and
means for mapping said each input parameter of said plurality of input parameters to a query parameter of said at least one query, said query parameter residing within a data structure connected to one data source of said plurality of disparate data sources.

24. The system according to claim 23, wherein said data structure further references a data reference structure specifying a link to said one data source.

25. The system according to claim 20, wherein at least one data source of said plurality of disparate data sources is a retailer located within a retailer level of said supply chain.

26. The system according to claim 25, wherein a predetermined number of data sources of said plurality of disparate data sources are manufacturers of products located within separate manufacturer levels of said supply chain.

27. The system according to claim 20, wherein at least one data source of said plurality of disparate data sources is a manufacturer of an end product located within a manufacturer level of said supply chain.

28. The system according to claim 27, wherein a predetermined number of data sources of said plurality of disparate data sources are suppliers of components for said end product located within separate supplier levels of said supply chain.

29. The system according to claim 20, wherein at least one data source of said plurality of disparate data sources is a supplier of compliance information related to manufacture of an end product, said at least one data source being located within a supplier level of said supply chain.

30. The method according to claim 16, wherein each data item of said plurality of data items is displayed in real time.

31. A compute readable medium containing executable instructions, which, when executed in a processing system, cause said processing system to perform an automated method to present data pertaining to an item collected from a plurality of disparate data sources, the method comprising:
retrieving a plurality of data items related to a request from a user from said plurality of disparate data sources, each data item of said plurality of data items pertaining to a distinct aspect of said item; and
displaying said plurality of data items in at least one window for said user.

32. The computer readable medium according to claim 31, wherein said plurality of disparate data sources are geographically disposed and coupled to a common network.

33. The computer readable medium according to claim 31, wherein said item is a composite item, and each data item of said plurality of data items pertains to a component of said composite item.

34. The computer readable medium according to claim 31, wherein each data source of said plurality of disparate data sources comprises an original publisher of a corresponding data item of said plurality of data items.

35. The computer readable medium according to claim 31, wherein each data source of said plurality of disparate data sources is located on separate levels of a supply chain.

36. The computer readable medium according to claim 31, wherein said plurality of data sources are disparate contributors to an end product.

37. The computer readable medium according to claim 31, wherein said retrieving further comprises:
transmitting at least one query to said plurality of disparate data sources; and
retrieving at least one data item of said plurality of data items, said at least one data item being associated with each data source of said plurality of disparate data sources.

38. The computer readable medium according to claim 37, wherein said method further comprises:
receiving a plurality of input parameters within said request from said user; and
mapping said each input parameter of said plurality of input parameters to a query parameter of said at least one query, said query parameter residing within a data structure connected to one data source of said plurality of disparate data sources.

39. The computer readable medium according to claim 38, wherein said data structure further references a data reference structure specifying a link to said one data source.

40. The computer readable medium according to claim 35, wherein at least one data source of said plurality of disparate data sources is a retailer located within a retailer level of said supply chain.

41. The computer readable medium according to claim 40, wherein a predetermined number of data sources of said plurality of disparate data sources are manufacturers of products located within separate manufacturer levels of said supply chain.

42. The computer readable medium according to claim 35, wherein at least one data source of said plurality of disparate data sources is a manufacturer of an end product located within a manufacturer level of said supply chain.

43. The computer readable medium according to claim 42, wherein a predetermined number of data sources of said plurality of disparate data sources are suppliers of components for said end product located within separate supplier levels of said supply chain.

44. The computer readable medium according to claim 35, wherein at least one data source of said plurality of disparate data sources is a supplier of compliance information related to manufacture of an end product, said at least one data source being located within a supplier level of said supply chain.

45. The computer readable medium according to claim 31, wherein each data item of said plurality of data items is displayed in real time.

46. A system to present data pertaining to an item collected from a plurality of disparate data sources, the system comprising:
a server module to retrieve a plurality of data items related to a request from a user from said plurality of disparate data sources, each data item of said plurality of data items pertaining to a distinct aspect of said item; and
a client module to display said plurality of data items in at least one window for said user.

47. The system according to claim 46, wherein said plurality of disparate data sources are geographically disposed and coupled to a common network.

48. The system according to claim 46, wherein said item is a composite item, and each data item of said plurality of data items pertains to a component of said composite item.

49. The system according to claim 46, wherein each data source of said plurality of disparate data sources comprises an original publisher of a corresponding data item of said plurality of data items.

50. The system according to claim 46, wherein each data source of said plurality of disparate data sources is located on separate levels of a supply chain.

51. The system according to claim 46, wherein said plurality of data sources are disparate contributors to an end product.

52. The system according to claim 46, wherein said server module further transmits at least one query to said plurality of disparate data sources and retrieves at least one data item of said plurality of data items, said at least one data item being associated with each data source of said plurality of disparate data sources.

53. The system according to claim 52, wherein said server module further receives a plurality of input parameters within said request from said user and maps said each input parameter of said plurality of input parameters to a query parameter of said at least one query, said query parameter residing within a data structure connected to one data source of said plurality of disparate data sources.

54. The system according to claim 53, wherein said data structure further references a data reference structure specifying a link to said one data source.

55. The system according to claim 50, wherein at least one data source of said plurality of disparate data sources is a retailer located within a retailer level of said supply chain.

56. The system according to claim 55, wherein a predetermined number of data sources of said plurality of disparate data sources are manufacturers of products located within separate manufacturer levels of said supply chain.

57. The system according to claim 50, wherein at least one data source of said plurality of disparate data sources is a manufacturer of an end product located within a manufacturer level of said supply chain.

58. The system according to claim 57, wherein a predetermined number of data sources of said plurality of disparate data sources are suppliers of components for said end product located within separate supplier levels of said supply chain.

59. The system according to claim 50, wherein at least one data source of said plurality of disparate data sources is a supplier of compliance information related to manufacture of an end product, said at least one data source being located within a supplier level of said supply chain.

60. The system according to claim 46, wherein each data item of said plurality of data items is displayed in real time.
